(19) United States
(12) Patent Application Publication
(10) Pub. No.: US 2025/0357545 A1
(43) Pub. Date: Nov. 20, 2025

(54) ETHER ELECTROLYTE SOLUTION AND APPLICATION OF ETHER ELECTROLYTE SOLUTION IN BATTERIES

(71) Applicant: UNIVERSITY OF SCIENCE AND TECHNOLOGY OF CHINA, Hefei, Anhui (CN)

(72) Inventors: Xiaodi REN, Hefei, Anhui (CN); Shunqiang CHEN, Hefei, Anhui (CN); Digen RUAN, Hefei, Anhui (CN)

(21) Appl. No.: 18/874,189

(22) PCT Filed: Mar. 14, 2023
(86) PCT No.: PCT/CN2023/081333

§ 371 Date: Dec. 12, 2024

(30) Foreign Application Priority Data
Jun. 16, 2022 (CN) 202210694715.6

(51) Int. Cl. H01M 10/0569; H01M 10/0525; H01M 10/054; H01M 10/0567; H01M 10/0568

(52) U.S. Cl. CPC H01M 10/0569; H01M 10/0525; H01M 10/054; H01M 10/0567; H01M 10/0568; H01M 2300/0028

(57) ABSTRACT

An ether electrolyte solution and an application of an ether electrolyte solution in a battery. The ether electrolyte solution includes: an ether solvent and an electrolyte salt; where the ether solvent includes an ether solvent A or an ether solvent B, a general structural formula of the ether solvent A is:

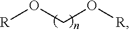

and a general structural formula of the ether solvent B is:

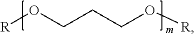

where a value of n is in a range of 3 to 4, a value of m is in a range of 1 to 3, and R is independently selected from any one of methyl, ethyl, chlorine, fluorine, monochloromethyl, dichloromethyl, trichloromethyl, monofluoromethyl, difluoromethyl, trifluoromethyl, monofluoroethyl, difluoroethyl, or trifluoroethyl.

### CROSS REFERENCE TO RELATED APPLICATION

This application is a Section 371 National Stage Application of International Application No. PCT/CN2023/081333, filed on Mar. 14, 2023, entitled “ETHER ELECTROLYTE SOLUTION AND APPLICATION OF ETHER ELECTROLYTE SOLUTION IN BATTERIES”, this application claims priority to Chinese Patent Application No. 202210694715.6 filed on Jun. 16, 2022, the content of which is incorporated herein by reference in its entirety.

### TECHNICAL FIELD

The present disclosure belongs to a field of batteries, and in particular relates to an ether electrolyte solution and an application of an ether electrolyte solution in a battery.

### BACKGROUND

A lithium metal battery (LMB) has characteristics such as a high energy density, etc., which is a next generation of energy storage battery system with a good application prospect. Compared with a traditional graphite negative electrode, a lithium metal has attracted attention of many scholars as well as companies due to a high theoretical specific capacity (3860 mAh g⁻¹) and a low standard electrode potential (−3.04 V, relative to a standard hydrogen electrode) thereof. A lithium metal battery with a high energy density may be obtained by matching the lithium metal with some positive electrode materials with a high voltage and a high capacity.

At present, two types of electrolyte solutions are commonly used in the lithium metal battery: a carbonate ester electrolyte solution and an ether electrolyte solution. An organic carbonate ether electrolyte is often used in a high-voltage lithium metal battery due to an excellent oxidation stability (>4.5 V, relative to Li/Li⁺) thereof. However, due to a strong reactivity between the carbonate ether electrolyte solution and the lithium metal, a continuous side reaction may easily lead to a decrease in a lithium metal coulombic efficiency (CE) and affect a long-cycle stability performance of an electrode of the lithium metal.

An ether electrolyte is a currently-known electrolyte solution with a good compatibility with the lithium metal, which has a good lithium metal coulombic efficiency and a capacity of suppressing a growth of a lithium dendrite, and therefore is very suitable for the lithium metal battery. However, ether electrolyte solutions have a low oxidation stability (<4 V, relative to Li/Li⁺), and are easily oxidized and decomposed on the surface of high-voltage positive electrodes. When a salt concentration of the ether electrolyte solution is 1 M, the ether electrolyte may not be used with high-voltage positive electrode materials (for example, a 4.3 V high-nickel LiNi_{0.8}Mn_{0.1}Co_{0.1}O₂ (NMC811) positive electrode). Therefore, an application of the ether electrolyte in a field of high-voltage batteries is limited.

### SUMMARY

In an aspect of the present disclosure, an ether electrolyte solution is provided, including: an ether solvent and an electrolyte salt;
where the ether solvent includes an ether solvent A or an ether solvent B, a general structural formula of the ether solvent A is:

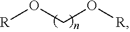

and a general structural formula of the ether solvent B is:

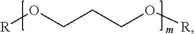

where a value of n is in a range of 3 to 4, a value of m is in a range of 1 to 3, and R is independently selected from any one of methyl, ethyl, chlorine, fluorine, monochloromethyl, dichloromethyl, trichloromethyl, monofluoromethyl, difluoromethyl, trifluoromethyl, monofluoroethyl, difluoroethyl, or trifluoroethyl.

In an embodiment, the ether electrolyte solution further includes: a diluent.

In an embodiment, the ether solvent A or the ether solvent B includes at least one of:

1,4-dimethoxybutane, 1,3-dimethoxypropane, 1,3-diethoxypropane, 1,3-bis (chloromethoxy) propane, 1-methoxy-3-(3-methoxypropoxy) propane, or 2,6,10,14-tetraoxapentadecane.

In an embodiment, the electrolyte salt includes any one or more of a lithium salt, a sodium salt, a potassium salt, a magnesium salt, or a zinc salt.

In an embodiment, the lithium salt includes any one or more of:
LiPF₆, LiBF₄, Li₂SO₄, LiClO₄, LiNO₃, LiCF₃SO₃, Li(CF₃SO₂)₂N, Li(FSO₂)₂N, or Li(CF₃CF₂SO₂)₂N;
the sodium salt includes any one or more of:
NaClO₄, NaNO₃, NaF, Na(FSO₂)₂N, Na(CF₃CF₂SO₂)₂N, NaPF₆, Na₂SO₄, or NaCF₃SO₃;
the potassium salt includes any one or more of:
KNO₃, KClO₄, KPF₆, K(FSO₂)₂N, K(CF₃SO₂)₂N, or K₂SO₄;
the magnesium salt includes any one or more of:
Mg(CF₃SO₃)₂, MgCl₂, or MgSO₄; and
the zinc salt includes any one or more of:
Zn(CF₃SO₃)₂, ZnSO₄, or Zn(CH₃OO)₂.

In an embodiment, a molar ratio of the ether solvent A and the electrolyte salt or a molar ratio of the ether solvent B and the electrolyte salt is in a range of 1:(0.2 to 5).

In an embodiment, the diluent includes at least one of: 1,1,2,2-tetrafluoroethyl-2,2,3,3-tetrafluoropropyl ether, 1-(2,2,2-trifluoroethoxy)-1,1,2,2-tetrafluoroethane, 1,1,2,2-tetrafluoroethyl-2,2,2-trifluoroethyl ether, bis(2,2,2-trifluoroethyl) ether, tris(2,2,2-trifluoroethyl) orthoformate, 1H,1H,5H-octafluoropentyl acrylate-1,1,2,2-tetrafluoroethyl ether, fluorobenzene, or 1,3,5 trifluorobenzene.

In an embodiment, a mass percentage of the ether solvent A in the ether electrolyte solution or a mass percentage of the ether solvent B in the ether electrolyte solution is in a range of 1% wt to 100% wt.

In an embodiment, a molar ratio of the ether solvent A, the electrolyte salt and the diluent or a molar ratio of the ether solvent B, the electrolyte salt and the diluent is in a range of 1:(0.2 to 5):(1 to 10).

In another aspect of the present disclosure, an application of an ether electrolyte solution in a battery is further provided, including using the ether electrolyte solution, where the battery includes a lithium metal battery, a lithium ion battery, a sodium metal battery, a sodium ion battery, a potassium metal battery, a potassium ion battery, a magnesium metal battery, or a zinc metal battery.

### BRIEF DESCRIPTION OF THE DRAWINGS

FIG. 1 shows a long-cycle stability diagram of a Li∥single crystalline NMC811 battery at a charging cut-off voltage of 4.7 V in ether electrolyte solutions in Embodiments 1 to 2 and Comparative Embodiment 1 of the present disclosure;

FIG. 2 shows a coulombic efficiency diagram of a Li∥single crystalline NMC811 battery at a charging cut-off voltage of 4.7 V in ether electrolyte solutions in Embodiments 1 to 2 and Comparative Embodiment 1 of the present disclosure;

FIG. 3A shows a voltage curve graph of a first cycle of charge and discharge of a Li∥single crystalline NMC811 battery at a charging cut-off voltage of 4.7 V in an ether electrolyte solution in Comparative Embodiment 1 of the present disclosure;

FIG. 3B shows a voltage curve graph of a first cycle of charge and discharge of a Li∥single crystalline NMC811 battery at a charging cut-off voltage of 4.7 V in an ether electrolyte solution in Embodiment 2 of the present disclosure;

FIG. 3C shows a voltage curve graph of a first cycle of charge and discharge of a Li∥single crystalline NMC811 battery at a charging cut-off voltage of 4.7 V in an ether electrolyte solution in Embodiment 1 of the present disclosure;

FIG. 4 shows a slow-charge and a fast-discharge performance diagram of a Li∥polycrystalline NMC811 battery at a charging cut-off voltage of 4.7 V in ether electrolyte solutions in Embodiments 1 to 2 and Comparative Embodiment 1 of the present disclosure;

FIG. 5 shows a fast-charge and a slow-discharge performance diagram of a Li∥polycrystalline NMC811 battery at a charging cut-off voltage of 4.7 V in ether electrolyte solutions in Embodiments 1 to 2 and Comparative Embodiment 1 of the present disclosure;

FIG. 6 shows a leakage current test diagram of a Li∥single crystalline NMC811 battery at a voltage of 4.7 V in ether electrolyte solutions in Embodiments 1 to 2 and Comparative Embodiment 1 of the present disclosure;

FIG. 7 shows a long-cycle stability diagram of a Li∥single crystalline NMC811 battery at a charging cut-off voltage of 4.7 V in an ether electrolyte solution in Embodiment 3 of the present disclosure;

FIG. 8 shows a voltage curve graph of a first cycle of charge and discharge of a Li∥single crystalline NMC811 battery at a charging cut-off voltage of 4.7 V in an ether electrolyte solution in Embodiment 4 of the present disclosure; and

FIG. 9 shows a long-cycle stability diagram of a Li∥single crystalline NMC811 battery at a charging cut-off voltage of 4.7 V in an ether electrolyte solution in embodiment 5 of the present disclosure.

### DETAILED DESCRIPTION OF EMBODIMENTS

Embodiments of the present disclosure will be further described below with reference to the accompanying drawings.

Based on a low oxidation stability of an ether electrolyte solution in prior art, when a concentration of the ether electrolyte solution is 1 M, the ether electrolyte solution is not suitable for high-voltage positive electrode materials, which limits an application of the ether electrolyte solution in a battery. Therefore, the present disclosure provides an ether electrolyte solution and an application of an ether electrolyte solution in a battery. It is desired that the ether electrolyte solution may have a high oxidation resistance capacity and a high-voltage resistance capacity in an application process of a positive electrode material, so as to improve a coulombic efficiency and a long-cycle stability of the battery in an actual application process.

According to embodiments of the present disclosure, an ether electrolyte solution is provided, including: an ether solvent and an electrolyte salt; where the ether solvent includes an ether solvent A or an ether solvent B, a general structural formula of the ether solvent A is:

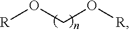

and a general structural formula of the ether solvent B is:

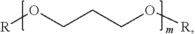

where a value of n is in a range of 3 to 4, a value of m is in a range of 1 to 3, and R is independently selected from any one of methyl, ethyl, chlorine, fluorine, monochloromethyl, dichloromethyl, trichloromethyl, monofluoromethyl, difluoromethyl, trifluoromethyl, monofluoroethyl, difluoroethyl, or trifluoroethyl.

According to embodiments of the present disclosure, in an ether electrolyte solution including the ether solvent A or the ether solvent B and the electrolyte salt, an oxidation resistance stability of the ether electrolyte solution may be optimized by adjusting the number of carbon atoms in an ether chain of the ether solvent A or the ether solvent B.

According to embodiments of the present disclosure, the ether electrolyte solution further includes: a diluent. That is, the ether electrolyte solution may be also composed of the ether solvent A or the ether solvent B, the electrolyte salt and the diluent.

According to embodiments of the present disclosure, the ether solvent A or the ether solvent B includes at least one of: 1,4-dimethoxybutane, 1,3-dimethoxypropane, 1,3-diethoxypropane, 1,3-bis(chloromethoxy) propane, 1-methoxy-3-(3-methoxypropoxy) propane, and 2,6,10,14-tetraoxapentadecane. The same is true for an ether solvent A composed of other R groups, which will not be defined more specifically in the present disclosure.

According to embodiments of the present disclosure, the electrolyte salt includes any one or more of a lithium salt, a sodium salt, a potassium salt, a magnesium salt, or a zinc salt.

According to embodiments of the present disclosure, the lithium salt includes any one or more of: LiPF₆, LiBF₄, Li₂SO₄, LiClO₄, LiNO₃, LiCF₃SO₃, Li(CF₃SO₂)₂N, Li(FSO₂)₂N, or Li(CF₃CF₂SO₂)₂N.

According to embodiments of the present disclosure, the sodium salt includes any one or more of: NaClO₄, NaNO₃, NaF, Na(FSO₂)₂N, Na(CF₃CF₂SO₂)₂N, NaPF₆, Na₂SO₄, or NaCF₃SO₃.

According to embodiments of the present disclosure, the potassium salt includes any one or more of: KNO₃, KClO₄, KPF₆, K(FSO₂)₂N, K(CF₃SO₂)₂N, or K₂SO₄.

According to embodiments of the present disclosure, the magnesium salt includes any one or more of: Mg(CF₃SO₃)₂, MgCl₂, or MgSO₄.

According to embodiments of the present disclosure, the zinc salt includes any one or more of: Zn(CF₃SO₃)₂, ZnSO₄, or Zn(CH₃OO)₂.

According to embodiments of the present disclosure, a molar ratio of the ether solvent A and the electrolyte salt or a molar ratio of the ether solvent B and the electrolyte salt is in a range of 1:(0.2 to 5). The molar ratio may be selected as: 1:0.2, 1:0.3, 1:0.4, 1:0.5, 1:1, 1:1.5, 1:2, 1:1.5, 1:2, 1:2.5, 1:3, 1:3.5, 1:4, 1:4.5, 1:5, etc.

In embodiments of the present disclosure, due to different solubility of the electrolyte salt in the ether solvent A or the ether solvent B, there are different ratios between the ether solvent A and the electrolyte salt and between the ether solvent B to the electrolyte salt. When the molar ratio of the ether solvent A and the electrolyte salt or the molar ratio of the ether solvent B and the electrolyte salt is low, that is, a content of the ether solvent A in the ether electrolyte solution or a content of the ether solvent B in the ether electrolyte solution is low, the oxidation resistance capacity of the ether electrolyte solution may be improved.

According to embodiments of the present disclosure, the diluent includes at least one of: 1,1,2,2-tetrafluoroethyl-2,2,3,3-tetrafluoropropyl ether, 1-(2,2,2-trifluoroethoxy)-1,1,2,2-tetrafluoroethane, 1,1,2,2-tetrafluoroethyl-2,2,2-trifluoroethyl ether, bis(2,2,2-trifluoroethyl) ether, tris(2,2,2-trifluoroethyl) orthoformate, 1H,1H,5H-octafluoropentyl acrylate-1,1,2,2-tetrafluoroethyl ether, fluorobenzene, or 1,3,5 trifluorobenzene.

According to embodiments of the present disclosure, in an ether electrolyte solution including the ether solvent A or the ether solvent B, the electrolyte salt and the diluent, the diluent be used to may decrease a viscosity of the ether electrolyte solution, so as to improve an ionic conductivity and a wettability of a metal electrode and the electrolyte solution.

According to embodiments of the present disclosure, in the ether electrolyte solution including the ether solvent A or the ether solvent B, the electrolyte salt and the diluent, a mass percentage of the ether solvent A in the ether electrolyte solution or a mass percentage of the ether solvent B in the ether electrolyte solution is in a range of 1% wt to 100% wt. The mass percentage may be selected as 1% wt, 2% wt, 3% wt, 4% wt, 5% wt, 10% wt, 15% wt, 20% wt, 30% wt, 40% wt, 50% wt, 60% wt, 70% wt, 80% wt, 90% wt, 100% wt, etc.

According to embodiments of the present disclosure, a molar ratio of the ether solvent A, the electrolyte salt and the diluent or a molar ratio of the ether solvent B, the electrolyte salt and the diluent is in a range of 1:(0.2 to 5):(1 to 10). The molar ratio may be selected as 1:0.64:3, 1:0.70:3, 1:0.75:3, 1:0.80:3, 1:0.85:3, 1:0.90:3, 1:0.95:3, 1:1.0:3, 1:1:3, 1:2:3, 1:2:4, 1:2:5, 1:2:6, 1:2:7, 1:2:8, 1:2:9, 1:2:10, 1:3:2, 1:3:5, 1:5:4, 1:5:6, 1:4:8, etc.

In embodiments of the present disclosure, due to different solubility of the electrolyte salt in the ether solvent A or the ether solvent B and the diluent, there are different mass percentages and molar ratios for the ether solvent A or the ether solvent B in the ether electrolyte solution. When the content of the ether solvent A in the ether electrolyte solution or the content of the ether solvent B in the ether electrolyte solution decreases, the oxidation resistance capacity of the ether electrolyte solution may be improved.

According to embodiments of the present disclosure, a service voltage of the ether electrolyte solution is greater than or equal to 4.2 V and up to 4.7 V.

According to embodiments of the present disclosure, an application of an ether electrolyte solution in a battery is further provided. The battery includes any one of a lithium metal battery, a lithium ion battery, a sodium metal battery, a sodium ion battery, a potassium metal battery, a potassium ion battery, a magnesium metal battery, or a zinc metal battery.

According to embodiments of the present disclosure, the battery includes: a positive electrode material, a negative electrode material or an ether electrolyte solution.

According to embodiments of the present disclosure, the negative electrode material includes: Li metal.

According to embodiments of the present disclosure, the positive electrode material includes: a positive electrode active material. The positive electrode active material includes a positive electrode active material with a thermodynamic electrochemical potential greater than 4.2 V.

According to embodiments of the present disclosure, the positive electrode active material includes at least one of: LiNi_{0.8}Co_{0.1}Mn_{0.1}O₂, LiMn₂O₄, LiMnO₄, LiMnO, or LiMnO₃.

In embodiments of the present disclosure, the ether electrolyte solution is used in a field of lithium metal batterie, which may improve an oxidation resistance capacity and a high-voltage resistance capacity (up to 4.7 V) of the ether electrolyte solution, so as to improve a coulombic efficiency and a stability of a long-term cycle work of the lithium metal battery in an actual application process.

The technical solutions of the present disclosure will be further described below with reference to specific embodiments and the accompanying drawings. It should be noted that the following specific embodiments are for an illustrative purpose merely, and the scope of protection of the present disclosure is not limited thereto. Chemicals and raw materials used in the following embodiments are commercially available or prepared by known preparation methods.

### COMPARATIVE EMBODIMENTS

### Comparative Embodiment 1

In Comparative Embodiment 1, an ether electrolyte solution is provided. The ether electrolyte solution is composed of an ether solvent A, an electrolyte salt and a diluent. The ether solvent A is 1,2-dimethoxyethane, the electrolyte salt is lithium bis(fluorosulfoni)mide, and the diluent is 1,1,2,2-tetrafluoroethyl-2,2,3,3-tetrafluoropropyl ether.

An ether electrolyte solution with a local high concentration is prepared by weighing the lithium bisfluorosulfonimide and adding 1,2-dimethoxyethane with a mass percentage of about 10% wt and the diluent therein. A concentration of the ether electrolyte solution is about 1 M, and the molar ratio of the ether solvent A, the electrolyte salt and the diluent is 1:1:3.

### EMBODIMENTS

### Embodiment 1

In Embodiment 1, an ether electrolyte solution is provided. The ether electrolyte solution is composed of an ether solvent A, an electrolyte salt and a diluent. The ether solvent A is 1,3-dimethoxypropane, the electrolyte salt is lithium bisfluorosulfonimide, and the diluent is 1,1,2,2-tetrafluoroethyl-2,2,3,3-tetrafluoropropyl ether.

An ether electrolyte solution with a local high concentration is prepared by weighing the lithium bisfluorosulfonimide and adding 1,3-dimethoxypropane with a mass percentage of about 10% wt and the diluent therein. The molar ratio of the ether solvent A, the electrolyte salt and the diluent is 1:1:3 (a concentration of the ether electrolyte solution is about 1 M).

### Embodiment 2

In Embodiment 2, an ether electrolyte solution is provided. The ether electrolyte solution is composed of an ether solvent A, an electrolyte salt and a diluent. The ether solvent A is 1,4-dimethoxybutane, the electrolyte salt is lithium bisfluorosulfonimide, and the diluent is 1,1,2,2-tetrafluoroethyl-2,2,3,3-tetrafluoropropyl ether.

An ether electrolyte solution with a local high concentration is prepared by weighing the lithium bisfluorosulfonimide and adding 1,4-dimethoxybutane with a mass percentage of about 12% wt and the diluent therein. The molar ratio of the ether solvent A, the electrolyte salt and the diluent is 1:1:3 (a concentration of the ether electrolyte solution is about 1 M).

The ether electrolyte solutions in Embodiments 1 to 2 are selected as study objects, and the ether electrolyte in Comparative Embodiment 1 is selected as a control group. A battery is fabricated by using a single crystalline NMC811 (LiNi_{0.8}Co_{0.1}Mn_{0.1}O₂) (2 mAh cm⁻²) as a positive electrode and a Li metal (450 μm) as a negative electrode. A charging and discharging operation is performed on the lithium metal battery fabricated in the ether electrolyte solutions in Embodiments 1 to 2 and Comparative Embodiment 1 at a charging cut-off voltage of 4.7 V, so as to test a cycle stability performance of the lithium metal battery in the ether electrolyte solutions. The specific test results are as shown in FIG. 1, where an amount of the ether electrolyte solution used is 75 μL.

FIG. 1 shows a long-cycle stability diagram of a Li∥single crystalline NMC811 battery at a charging cut-off voltage of 4.7 V in ether electrolyte solutions in Embodiments 1 to 2 and Comparative Embodiment 1 of the present disclosure.

As shown in FIG. 1, a battery in Comparative Embodiment 1 has a battery capacity of only 4% after 150 cycles. It should be noted that a capacity of an electrolyte solution battery in Embodiment 2 fades quickly in the first 50 cycles, which indicates that the oxidation resistance capacity of the ether electrolyte solution in Embodiment 2 is poor. In order to explore whether the positive electrode material (single crystalline NMC811) in Embodiment 2 causes a sharp decrease in the battery capacity, the battery after 50 cycles is replaced with a new Li electrode sheet and a long-time cycle test is performed again. It is found that after the replacing with the new Li electrode sheet, a cycle stability of the battery in Embodiment 2 does not recover and continues to decrease, which indicates that the positive electrode in Embodiment 2 has a serious side reaction, resulting in the sharp decrease in the lithium metal battery capacity. Compared with Embodiment 2 and Comparative Embodiment 1, a capacity retention rate of the Li∥single crystalline NMC811 battery in Embodiment 1 is as high as 87% after 150 times of tests on the cycle stability of the Li∥NMC811 battery at a voltage of 4.7 V, which indicates that the ether electrolyte solution in Embodiment 1 has a high oxidation resistance capacity. This may be because an excellent protection layer is formed, so that the single crystalline NMC811 has a good stability.

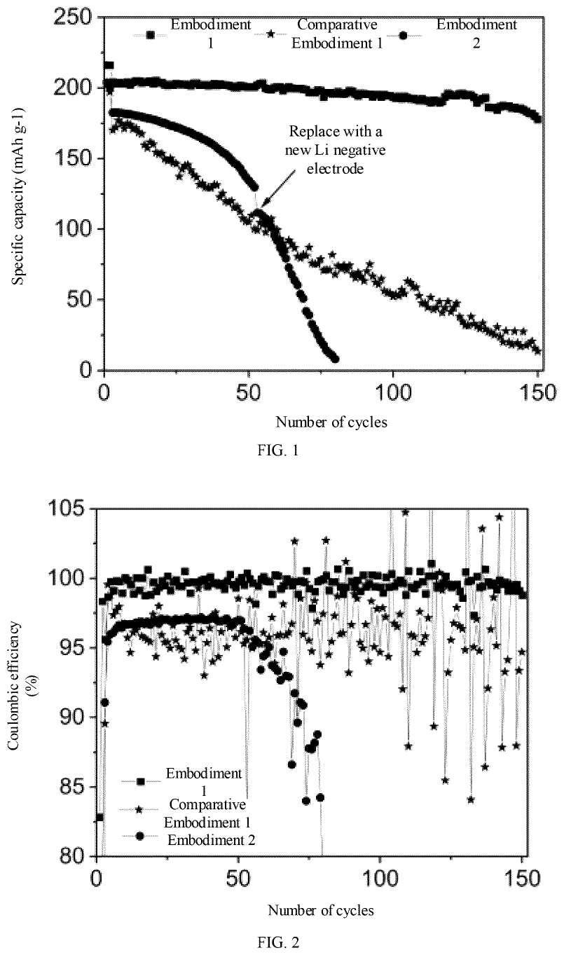

FIG. 2 shows a coulombic efficiency diagram of a Li∥single crystalline NMC811 battery at a voltage of 4.7 V in ether electrolyte solutions in Embodiments 1 to 2 and Comparative Embodiment 1 of the present disclosure.

As shown in FIG. 2, compared with coulombic efficiencies of the ether electrolyte solutions in Comparative Embodiment 1 and Embodiment 2, the ether electrolyte solution battery in Embodiment 1 has a high coulombic efficiency of 99.5% at a charging cut-off voltage of 4.7 V, while the coulombic efficiencies of the ether electrolyte solution batteries in Comparative Embodiment 1 and Embodiment 2 are only 95.6% and 94.1%, respectively. The high coulombic efficiency of the electrolyte solution in Embodiment 1 also corresponds to a good long-cycle stability performance of the electrolyte solution.

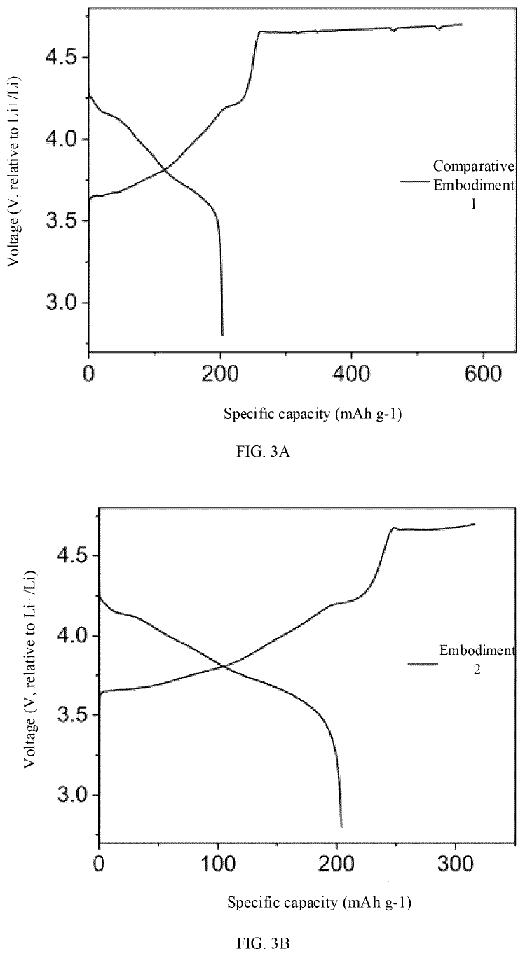

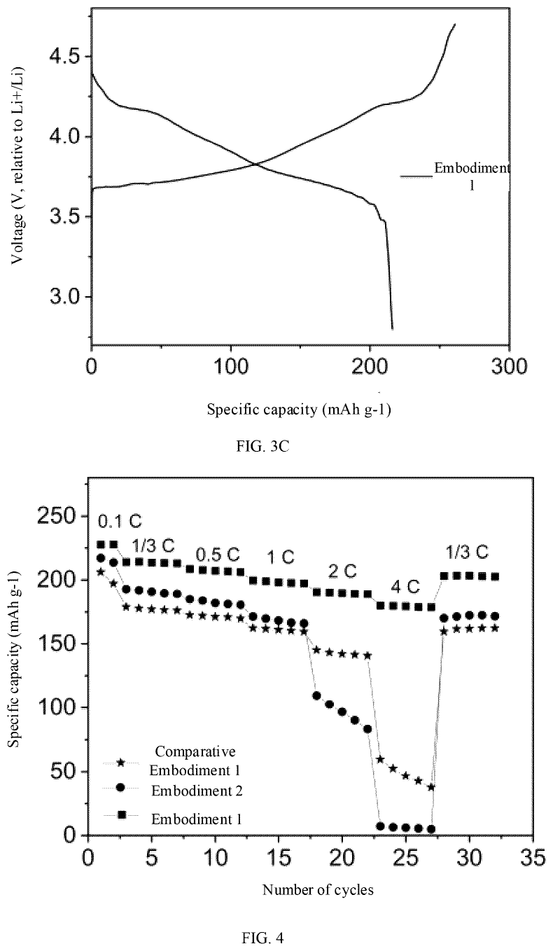

FIG. 3A shows a curve graph of a first cycle of charge and discharge of a Li∥single crystalline NMC811 battery at a charging cut-off voltage of 4.7 V in an ether electrolyte solution in Comparative Embodiment 1 of the present disclosure; FIG. 3B shows a curve graph of a first cycle of charge and discharge of a Li∥single crystalline NMC811 battery at a charging cut-off voltage of 4.7 V in an ether electrolyte solution in Embodiment 2 of the present disclosure; and FIG. 3C shows a curve graph of a first cycle of charge and discharge of a Li∥single crystalline NMC811 battery at a voltage of 4.7 V in an ether electrolyte solution in Embodiment 1 of the present disclosure.

As shown in FIG. 3A to FIG. 3C, when the voltage reaches 4.7 V, an obvious overcharge phenomenon caused by a decomposition of the electrolyte solution occurs in the ether electrolyte solution batteries in Comparative Embodiment 1 and Embodiment 2. Such a serious decomposition of the electrolyte solution may not only cause a large decrease in an amount of the electrolyte solution of the battery, but also lead to an obvious breakage of positive electrode single crystalline NMC811 particles caused by an acidic substance produced by the decomposition of the electrolyte solution, further inducing a transition metal to be dissolved out from an inside of the negative electrode particles and resulting in a serious fading of a discharge capacity in the first cycle. Such a serious side reaction may exacerbate an accumulation of side reactions in a subsequent cycle of the battery. However, there is no battery overcharge phenomenon in the ether electrolyte solution in Embodiment 1, which indicates that the ether electrolyte solution in Embodiment 1 has no obvious side reaction with the positive electrode at a high voltage, and indicates that the electrolyte solution in Embodiment 1 has a strong oxidation resistance capacity compared with the electrolyte solutions in Comparative Embodiment 1 and Embodiment 2.

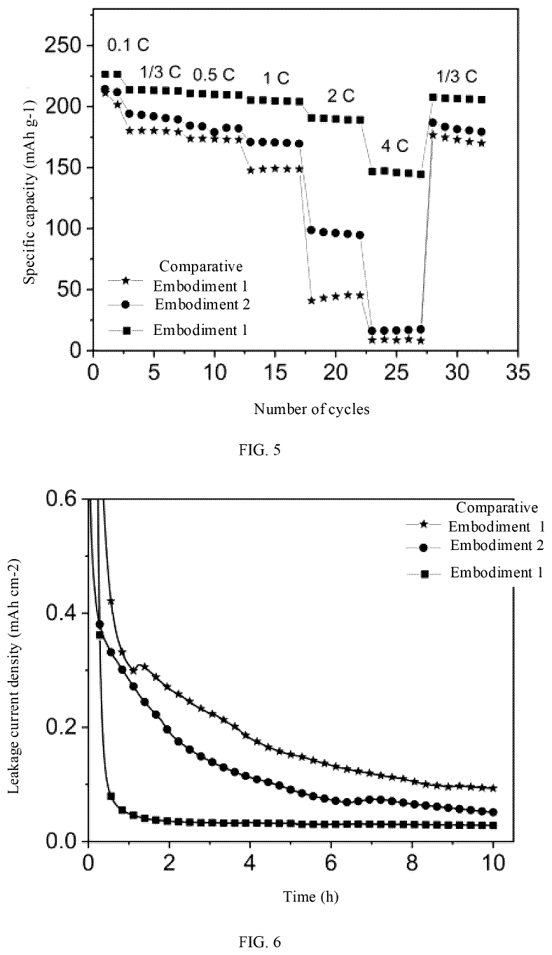

In order to study the charge and discharge performance of the ether electrolyte solution battery at different rates, the ether electrolyte solutions in Embodiments 1 to 2 are selected as study objects, and the ether electrolyte solution in Comparative Embodiment 1 is selected as a control group. A battery is fabricated by using a polycrystalline NMC811 (LiNi_{0.8}Co_{0.1}Mn_{0.1}O₂) (2 mAh cm⁻²) as a positive electrode and a Li metal (450 μm) as a negative electrode. A charging and discharging operation is performed on the battery fabricated by the ether electrolyte solutions in Embodiments 1 to 2 and Comparative Embodiment 1 at a charging cut-off voltage of 4.7 V, so as to test a rate performance of the battery in the ether electrolyte solutions at different rates. The specific test results are as shown in FIG. 4 and FIG. 5, where an amount of the ether electrolyte solution of the lithium metal battery is 75 μL.

Firstly, in Embodiments 1 to 2 and Comparative Embodiment 1, charging at the same rate (⅓ C) and discharging at different rates are performed. The specific results are as shown in FIG. 4.

FIG. 4 shows a slow-charge and a fast-discharge performance diagram of a Li∥polycrystalline NMC811 battery at a charging cut-off voltage of 4.7 V in ether electrolyte solutions in Embodiments 1 to 2 and Comparative Embodiment 1 of the present disclosure.

It may be found in FIG. 4 that under a condition of a fast discharge of 4C of the ether electrolyte solution, a specific capacity of the ether electrolyte solution battery is less than 50 mAh g⁻¹ in Comparative Embodiment 1, while a specific capacity of the ether electrolyte solution battery in Embodiment 2 is 5 mAh g⁻¹. Such a phenomenon is attributed to the serious decomposition of the electrolyte solutions in Comparative Embodiment 1 and Embodiment 2 at a charging cut-off voltage of 4.7 V, which leads to a sharp increase in an interface impedance of the positive electrode, resulting in a cliff-like decline in the rate performance of the battery. However, a specific capacity of the ether electrolyte solution battery in Embodiment 1 is as high as 180 mAh g⁻¹, which is mainly because the ether electrolyte solution in Embodiment 1 has a strong oxidation resistance capacity and a high ionic conductivity.

Secondly, charging at different rates and discharging at the same rate (⅓ C) are performed in Embodiments 1 to 2 and Comparative Embodiment 1. The specific test results are as shown in FIG. 5.

FIG. 5 shows a fast-charge and a slow-discharge performance diagram of a Li∥polycrystalline NMC811 battery at a charging cut-off voltage of 4.7 V in ether electrolyte solutions in Embodiments 1 to 2 and Comparative Embodiment 1 of the present disclosure.

As shown in FIG. 5, specific capacities of the ether electrolyte solution batteries are lower than 10 mAh g⁻¹ under a condition of a fast charge of 4 C of the ether electrolyte solutions in Comparative Embodiment 1 and Embodiment 2, while a specific capacity of the battery is as high as 147 mAh g⁻¹ under a condition of a fast discharge of 4 C of the ether electrolyte solution in Embodiment 1.

In order to better illustrate that the ether electrolyte solution in Embodiment 1 has a high oxidation resistance capacity, leakage current performances of the ether electrolyte solution batteries in Embodiments 1 to 2 and Comparative Embodiment 1 is explored. A leakage current may truly reflect a reaction between an electrolyte solution and a positive electrode. The lower the leakage current, the less a side reaction between the positive electrode and the electrolyte solution. The ether electrolyte solutions in Embodiments 1 to 2 are selected as study objects, and the ether electrolyte solution in Comparative Embodiment 1 is selected as a control group. A battery is fabricated by using a single crystalline NMC811 (LiNi_{0.8}Co_{0.1}Mn_{0.1}O₂) (2 mAh cm⁻²) as a positive electrode and a Lithium metal (450 μm) as a negative electrode, so as to perform a constant potential test. The specific test results are as shown in FIG. 6.

FIG. 6 shows a leakage current test diagram of a Li∥single crystalline NMC811 battery at a voltage of 4.7 V in ether electrolyte solutions in Embodiments 1 to 2 and Comparative Embodiment 1 of the present disclosure.

As shown in FIG. 6, from the leakage current test on the ether electrolyte solution batteries in Embodiments 1 to 2 and Comparative Embodiment 1, it may be found that Embodiment 1 shows a lower leakage current with a leakage current density of about 28 μA/cm², while Comparative Embodiment 1 shows the largest leakage current with a leakage current density of about 92 μA/cm², followed by a leakage current density of 51 μA/cm² in Embodiment 2, which sufficiently indicates that the side reaction between the ether electrolyte solution and the positive electrode in Embodiment 1 is minimal, so that the ether electrolyte solution has a strong oxidation resistance capacity. The experimental results are consistent with the above-mentioned experimental results.

### Embodiment 3

In Embodiment 3, an ether electrolyte solution is provided. The ether electrolyte is composed of an ether solvent A and an electrolyte salt. The ether solvent A is 1,3-dimethoxypropane, and the electrolyte salt is lithium bisfluorosulfonimide.

An ether electrolyte solution with a super-concentrated concentration is prepared by weighing the lithium bisfluorosulfonimide and adding 1,3-dimethoxypropane with a mass percentage of about 36% wt and a diluent therein. The molar ratio of the ether solvent A and the electrolyte salt is 1:1.

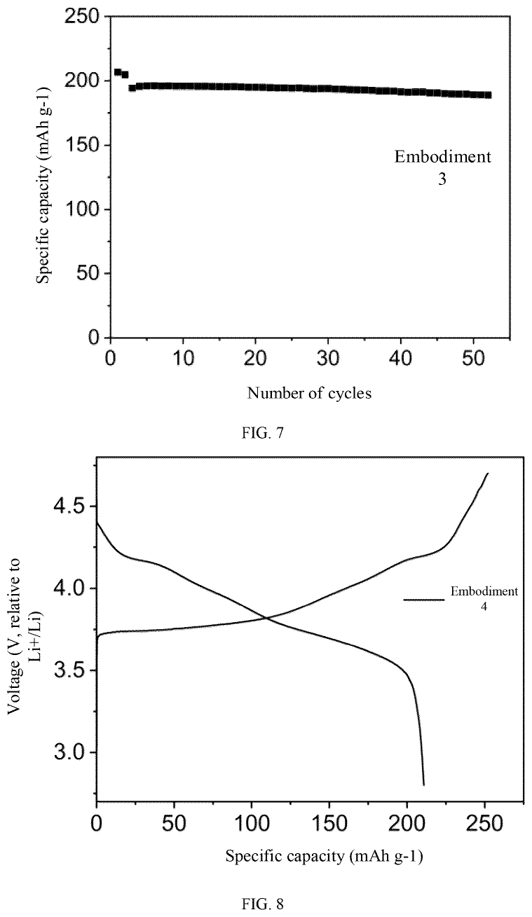

The ether electrolyte solution in Embodiment 3 is selected as a study object. An ether electrolyte solution battery is fabricated by using a single crystalline NMC811 (LiNi_{0.8}Co_{0.1}Mn_{0.1}O₂) (2 mAh cm⁻²) as a positive electrode and a Li metal (450 μm) as a negative electrode. A charging and discharging operation is performed on the ether electrolyte solution battery in Embodiment 3 at a charging cut-off voltage of 4.7 V, so as to test a long-cycle performance of the battery. The specific test results are as shown in FIG. 7, where an amount of the ether electrolyte solution is 75 μL.

FIG. 7 shows a long-cycle stability diagram of a Li∥single crystalline NMC811 battery at a charging cut-off voltage of 4.7 V in an ether electrolyte solution in Embodiment 3 of the present disclosure.

As shown in FIG. 7, it is found that even in an ether electrolyte solution system with a high concentration, the ether electrolyte solution battery in Embodiment 3 still has a high capacity retention rate of about 97.5% after 50 cycles, which indicates that the lithium metal battery in Embodiment 3 may exhibit a high high-voltage resistance (4.7 V) performance even without use of the diluent.

In order to explore an influence of other diluents on the oxidation resistance capacity of the ether electrolyte solution, Embodiment 4 is carried out.

### Embodiment 4

In Embodiment 4, an ether electrolyte solution is provided. The ether electrolyte is composed of an ether solvent A, an electrolyte salt and a diluent. The ether solvent A is 1,3-dimethoxypropane, the electrolyte salt is lithium bisfluorosulfonimide, and the diluent is 1-(2,2,2-trifluoroethoxy)-1,1,2,2-tetrafluoroethane.

An ether electrolyte solution with a local high concentration is prepared by weighing the lithium bisfluorosulfonimide and adding 1,3-dimethoxypropane with a mass percentage of about 11% wt and the diluent therein. The molar ratio of the ether solvent A, the electrolyte salt and the diluent is 1:1:3 (a concentration of the ether electrolyte solution is about 1.2 M).

The ether electrolyte solution in Embodiment 4 is selected as a study object. An ether electrolyte solution battery is fabricated using a single crystalline NMC811 (LiNi_{0.8}Co_{0.1}Mn_{0.1}O₂) (2 mAh cm⁻²) as a positive electrode and a Li metal (450 μm) as a negative electrode. A charging and discharging operation is performed on the ether electrolyte solution battery in Embodiment 4 at a voltage of 4.7 V, so as to test a long-cycle performance of the battery. The specific test results are as shown in FIG. 8, where an amount of the ether electrolyte solution is 75 μL.

FIG. 8 shows a curve graph of a first cycle of charge and discharge of a Li∥single crystalline NMC811 battery at a charging cut-off voltage of 4.7 V in an ether electrolyte solution in Embodiment 4 of the present disclosure.

As shown in FIG. 8, the ether electrolyte solution is prepared by replacing with another diluent. Compared with Embodiment 1 and Comparative Embodiment 1, no obvious overcharge phenomenon occurs in the first cycle in Embodiment 4, which indicates that the ether electrolyte solution prepared after replacing with another diluent may also have a good oxidation resistance capacity at a high voltage of 4.7 V.

### Embodiment 5

In Embodiment 5, an ether electrolyte solution is provided. The ether electrolyte is composed of an ether solvent B, an electrolyte salt and a diluent. The ether solvent Bis 1-methoxy-3-(3-methoxypropoxy) propane, the electrolyte salt is lithium bisfluorosulfonimide, and the diluent is 1,1,2,2-tetrafluoroethyl-2,3,3-tetrafluoropropyl ether.

An ether electrolyte solution with a local high concentration is prepared by weighing the lithium bisfluorosulfonimide and adding 1-methoxy-3-(3-methoxypropoxy) propane with a mass percentage of about 10% wt and the diluent therein. The molar ratio of the ether solvent B, the electrolyte salt and the diluent is 1:1:3 (a concentration of the ether electrolyte solution is about 1 M).

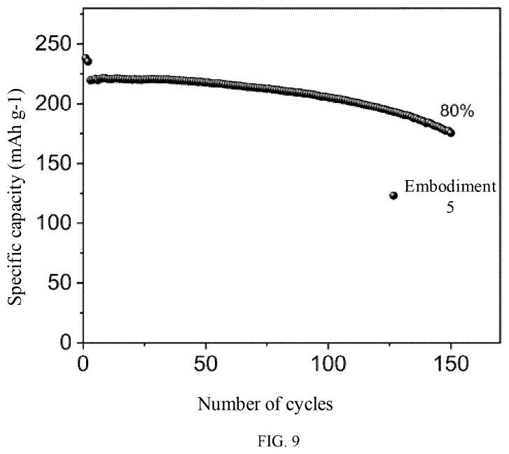

The ether electrolyte solution in Embodiment 5 is selected as a study object. An ether electrolyte solution battery is fabricated by using a single crystalline NMC811 (LiNi_{0.8}Co_{0.1}Mn_{0.1}O₂) (2 mAh cm⁻²) as a positive electrode and a Li metal (450 μm) as a negative electrode. A charging and discharging operation is performed on the ether electrolyte solution battery in Embodiment 5 at a charging cut-off voltage of 4.7 V, so as to test a long-cycle performance of the battery. The specific test results are as shown in FIG. 9, where an amount of the ether electrolyte solution is 75 μL.

FIG. 9 shows a long-cycle stability diagram of a Li∥single crystalline NMC811 battery at a charging cut-off voltage of 4.7 V in an ether electrolyte solution in Embodiment 5 of the present disclosure.

As shown in FIG. 9, a capacity retention rate of the ether electrolyte solution in Embodiment 5 is 80% after 150 cycles at a high charging cut-off voltage of 4.7 V, showing a good oxidation resistance capacity. Such an ether electrolyte solution with a good oxidation resistance is mainly attributed to an extension of an ether chain of the ether solvent B, which may further reduce the highest occupied molecular orbital energy level of the ether solvent itself and promote a formation of a more protective membrane, so as to reduce an occurrence of the side reaction between the ether electrolyte solution and the positive electrode.

Based on the above-mentioned technical solutions, an ether electrolyte solution and an application of an ether electrolyte solution in a battery provided by the present disclosure include at least one of the following beneficial effects:
(1) In embodiments of the present disclosure, an ether electrolyte solution including the ether solvent A or the ether solvent B and the electrolyte salt is provided. By adjusting the number of carbon atoms in an ether chain of the ether solvent A or the ether solvent B and controlling a ratio of the ether solvent A and the electrolyte salt or a ratio of the ether solvent B and the electrolyte salt, an oxidation resistance stability of the ether electrolyte solution may be optimized.
(2) In embodiments of the present disclosure, an ether electrolyte solution including the ether solvent A or the ether solvent B, the electrolyte salt and the diluent is further provided. By adjusting the number of carbon atoms in an ether chain of the ether solvent A or the ether solvent B and controlling a ratio of the ether solvent A, the electrolyte salt and the diluent or a ratio of the ether solvent A or the ether solvent B, the electrolyte salt and the diluent, an oxidation resistance capacity and a high-voltage resistance (up to 4.7 V) performance of the ether electrolyte solution may be further improved, so as to improve a coulombic efficiency of the lithium metal battery.

The above-mentioned specific embodiments of the present disclosure do not constitute a limitation to the scope of protection of the present disclosure. Various other corresponding changes and modifications made in accordance with the technical concept of the present disclosure should fall within the scope of protection of the claims of the present disclosure.

1. An ether electrolyte solution, comprising:
an ether solvent and an electrolyte salt;
wherein the ether solvent comprises an ether solvent A or an ether solvent B, a general structural formula of the ether solvent A is: 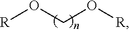
and a general structural formula of the ether solvent B is: 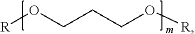
where a value of n is in a range of 3 to 4, a value of m is in a range of 1 to 3, and R is independently selected from any one of methyl, ethyl, chlorine, fluorine, monochloromethyl, dichloromethyl, trichloromethyl, monofluoromethyl, difluoromethyl, trifluoromethyl, monofluoroethyl, difluoroethyl, or trifluoroethyl.

2. The ether electrolyte solution according to claim 1, further comprising: a diluent.

3. The ether electrolyte solution according to claim 1, wherein the ether solvent A or the ether solvent B comprises at least one of:
1,4-dimethoxybutane, 1,3-dimethoxypropane, 1,3-diethoxypropane, 1,3-bis (chloromethoxy) propane, 1-methoxy-3-(3-methoxypropoxy) propane, or 2,6,10,14-tetraoxapentadecane.

4. The ether electrolyte solution according to claim 1, wherein the electrolyte salt comprises any one or more of a lithium salt, a sodium salt, a potassium salt, a magnesium salt, or a zinc salt.

5. The ether electrolyte solution according to claim 4, wherein the lithium salt comprises any one or more of:
LiPF₆, LiBF₄, Li₂SO₄, LiClO₄, LiNO₃, LiCF₃SO₃, Li(CF₃SO₂)₂N, Li(FSO₂)₂N, or Li(CF₃CF₂SO₂)₂N;
the sodium salt comprises any one or more of:
NaClO₄, NaNO₃, NaF, Na(FSO₂)₂N, Na(CF₃CF₂SO₂)₂N, NaPF₆, Na₂SO₄, or NaCF₃SO₃;
the potassium salt comprises any one or more of:
KNO₃, KClO₄, KPF₆, K(FSO₂)₂N, K(CF₃SO₂)₂N, or K₂SO₄;
the magnesium salt comprises any one or more of:
Mg(CF₃SO₃)₂, MgCl₂, or MgSO₄; and
the zinc salt comprises any one or more of:
Zn(CF₃SO₃)₂, ZnSO₄, or Zn(CH₃OO)₂.

6. The ether electrolyte solution according to claim 1, wherein a molar ratio of the ether solvent A and the electrolyte salt or a molar ratio of the ether solvent B and the electrolyte salt is in a range of 1:(0.2 to 5).

7. The ether electrolyte solution of claim 2, wherein the diluent comprises at least one of:
1,1,2,2-tetrafluoroethyl-2,2,3,3-tetrafluoropropyl ether, 1-(2,2,2-trifluoroethoxy)-1,1,2,2-tetrafluoroethane, 1,1,2,2-tetrafluoroethyl-2,2,2-trifluoroethyl ether, bis(2,2,2-trifluoroethyl) ether, tris(2,2,2-trifluoroethyl) orthoformate, 1H,1H,5H-octafluoropentyl acrylate-1,1,2,2-tetrafluoroethyl ether, fluorobenzene, or 1,3,5 trifluorobenzene.

8. The ether electrolyte solution according to claim 1, wherein a mass percentage of the ether solvent A in the ether electrolyte solution or a mass percentage of the ether solvent B in the ether electrolyte solution is in a range of 1% wt to 100% wt.

9. The ether electrolyte solution according to claim 2, wherein a molar ratio of the ether solvent A, the electrolyte salt and the diluent or a molar ratio of the ether solvent B, the electrolyte salt and the diluent is in a range of 1:(0.2 to 5):(1 to 10).

10. An application of an ether electrolyte solution in a battery, comprising using the ether electrolyte solution according to claim 1, wherein the battery comprises a lithium metal battery, a lithium ion battery, a sodium metal battery, a sodium ion battery, a potassium metal battery, a potassium ion battery, a magnesium metal battery, or a zinc metal battery.
